(19) United States
(12) Patent Application Publication
(10) Pub. No.: US 2019/0027149 A1
(43) Pub. Date: Jan. 24, 2019

(54) DOCUMENTATION TAG PROCESSING SYSTEM

(71) Applicant: Nuance Communications, Inc., Burlington, MA (US)

(72) Inventor: Markus Vogel, Dusseldorf (DE)

(73) Assignee: Nuance Communications, Inc., Burlington, MA (US)

(21) Appl. No.: 15/655,139

(22) Filed: Jul. 20, 2017

(51) Int. Cl. G10L 15/26; G06F 19/00; G06F 17/30

(52) U.S. Cl. CPC G10L 15/265; G06F 17/3043; G06F 19/322

(57) ABSTRACT

Described herein are embodiments of a system configured to receive text input (e.g., in the form of speech input) that includes provisional text and interpret the provisional text to produce substitute text with which the provisional text is replaced. A user dictating speech input may dictate the provisional text along with other content of the speech, and the speech input including the provisional text may be converted to text in a speech recognition process performed by an automatic speech recognition (ASR) system. The text corresponding to the speech input may be reviewed to determine whether any character strings included in the text match a character pattern defined for provisional text. If so, the character string is interpreted to determine a data field indicated by the provisional text, and substitute text including a value for the data field is determined. The provisional text may then be replaced with the substitute text.

### BACKGROUND

Automatic speech recognition (ASR) includes transcription, by machine, of audio speech into text. ASR is useful in a variety of applications, including in dictation software that recognizes user speech and outputs corresponding automatically-transcribed text. A typical dictation application may output the transcribed text of the dictated speech to a visual display for the user's review, often in near real-time while the user is in the process of dictating a passage or document. For example, a user may dictate a portion of a passage, the dictation application may process the dictated speech by ASR and output the corresponding transcribed text, and the user may continue to dictate the next portion of the same passage, which may subsequently be processed, transcribed, and output. Alternatively or additionally, some dictation applications may output text transcriptions via one or more other media, such as printing on a physical substrate such as paper, transmitting the text transcription to a remote destination, non-visual text output such as Braille output, etc.

### SUMMARY

One type of embodiment is directed to a method comprising evaluating text resulting from performance of automatic speech recognition (ASR) on audio of speech to determine whether the text includes provisional text. Evaluating the text comprises determining whether character strings of the text match a character pattern for provisional text. The method further comprises, in response to identifying a provisional text in the text, interpreting the provisional text to yield substitute text, the substitute text including a value for a data field that the interpreting determines is indicated by the provisional text, and editing the text to replace the provisional text with the substitute text.

Another type of embodiment is directed to at least one computer-readable storage medium having encoded thereon executable instructions that, when executed by at least one processor, cause the at least one processor to carry out a method. The method comprises evaluating text to determine whether the text includes provisional text, where evaluating the text comprises determining whether character strings of the text match a character pattern for provisional text. The method further comprises, in response to identifying a provisional text in the text, interpreting the provisional text to yield substitute text, the substitute text including a value for a data field that the interpreting determines is indicated by the provisional text, and editing the text to replace the provisional text with the substitute text.

Another type of embodiment is directed to an apparatus comprising at least one processor and at least one storage medium having encoded thereon executable instructions that, when executed by the at least one processor, cause the at least one processor to carry out a method. The method comprises evaluating text to determine whether the text includes provisional text. Evaluating the text comprises determining whether character strings of the text match a character pattern for provisional text. The method further comprises, in response to identifying a provisional text in the text, interpreting the provisional text to yield substitute text, the substitute text including a value for a data field that the interpreting determines is indicated by the provisional text, and editing the text to replace the provisional text with the substitute text.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of an illustrative computer system with which some embodiments may operate;

FIG. 2 is a flowchart of a process that may be implemented in some embodiments to interpret provisional text and replace the provisional text with a substitute text;

FIG. 3 is a flowchart of a process that may be implemented in some embodiments to identify provisional text in a text;

FIG. 4 is a flow diagram illustrating data flows that may in some embodiments accompany a process such as the process of FIG. 3;

FIG. 5 is a flowchart of a process that may be implemented in some embodiments to regulate access to a data store based on an authorization string;

FIG. 6 is a flowchart of a process that may be implemented in some embodiments to interpret command strings and execute indicated programmatic actions;

FIG. 7 is a flowchart of a process that may be implemented in some embodiments to generate documents using tag strings;

FIG. 8 is a flowchart of a process that may be implemented in some embodiments to store information using tag strings;

FIG. 9 is a flowchart of a process that may be implemented in some embodiments to store textual data items using tag strings;

FIG. 10 is a flowchart of a process that may be implemented in some embodiments for mapping defined fields of a form to data fields of a data store;

FIG. 11 is an example of a form with which some embodiments may operate;

FIG. 12 is a flowchart of a process that may be implemented in some embodiments to store information using a form that may not be editable;

FIG. 13 is an example of an uneditable document with which some embodiments may operate;

FIG. 14 is a flowchart of a process that may be implemented in some embodiments to store an image of text using storage strings; and

FIG. 15 is a block diagram of an exemplary computer system with which some embodiments may be implemented.

### DETAILED DESCRIPTION

Described herein are embodiments of a system providing for receiving input (e.g., speech input) that includes provisional text and interpretation of the provisional text to produce substitute information (e.g., text) with which the provisional text is replaced. A user dictating speech input may dictate the provisional text along with other content of the speech, and the speech input including the provisional text may be converted to text in a speech recognition process performed by an automatic speech recognition (ASR) system. The text corresponding to the speech input may be reviewed to determine whether any character strings included in the text match a character pattern defined for provisional text, such as whether the text includes a word beginning with a defined character symbol. If so, the character string is interpreted to determine a data field indicated by the provisional text, and substitute text including a value for the data field is determined. The provisional text may then be replaced with the substitute text, in the text that was output by the ASR system. In some embodiments, the speech input may relate to a medical report.

Medical documentation is an important part of the healthcare industry. Most healthcare institutions maintain a longitudinal medical record (e.g., spanning multiple observations or treatments over time) for each of their patients, documenting, for example, the patient's history, encounters with clinical staff within the institution, treatment received, and/or plans for future treatment. Such documentation facilitates maintaining continuity of care for the patient across multiple encounters with various clinicians over time. In addition, when an institution's medical records for large numbers of patients are considered in the aggregate, the information contained therein can be useful for educating clinicians as to treatment efficacy and best practices, for internal auditing within the institution, for quality assurance, etc.

Historically, each patient's medical record was maintained as a physical paper folder, often referred to as a “medical chart,” or “chart.” Each patient's chart would include a stack of paper reports, such as intake forms, history and immunization records, laboratory results and clinicians' notes. Following an encounter with the patient, such as an office visit, a hospital round or a surgical procedure, the clinician conducting the encounter would provide a narrative note about the encounter to be included in the patient's chart. Such a note could include, for example, a description of the reason(s) for the patient encounter, an account of any vital signs, test results and/or other clinical data collected during the encounter, one or more diagnoses determined by the clinician from the encounter, and a description of a plan for further treatment. Often, the clinician would verbally dictate the note into an audio recording device or a telephone giving access to such a recording device, to spare the clinician the time it would take to prepare the note in written form. Later, a medical transcriptionist would listen to the audio recording and transcribe it into a text document, which would be inserted on a piece of paper into the patient's chart for later reference.

Currently, many healthcare institutions are transitioning or have transitioned from paper documentation to electronic medical record systems, in which patients' longitudinal medical information is stored in a data repository in electronic form. Besides the significant physical space savings afforded by the replacement of paper record-keeping with electronic storage methods, the use of electronic medical records also provides beneficial time savings and other opportunities to clinicians and other healthcare personnel. For example, when updating a patient's electronic medical record to reflect a current patient encounter, a clinician need only document the new information obtained from the encounter, and need not spend time entering unchanged information such as the patient's age, gender, medical history, etc. Electronic medical records can also be shared, accessed and updated by multiple different personnel from local and remote locations through suitable user interfaces and network connections, eliminating the need to retrieve and deliver paper files from a crowded file room. An Electronic Health Record (EHR), or electronic medical record (EMR), is a digitally stored collection of health information that generally is maintained by a specific healthcare institution and contains data documenting the care that a specific patient has received from that institution over time. Typically, an EHR is maintained as a structured data representation, such as a database with structured fields. Each piece of information stored in such an EHR is typically represented as a discrete (e.g., separate) data item occupying a data field of the EHR database. For example, a 55-year old male patient named John Doe may have an EHR database record with “John Doe” stored in the patient_name data field, “55” stored in the patient_age data field, and “Male” stored in the patient_gender data field. Data items or fields in such an EHR are structured in the sense that only a certain limited set of valid inputs is allowed for each data field. For example, the patient_name data field may require an alphabetic string as input, and may have a maximum length limit; the patient_age data field may require a string of three numerals, and the leading numeral may have to be “0” or “1;” the patient_gender data field may only allow one of two inputs, “Male” and “Female;” a patient_birth_date data field may require input in a “MM/DD/YYYY” format; etc.

To allow clinicians and other healthcare personnel to enter medical documentation data directly into an EHR in its discrete structured data format, many EHRs are accessed through user interfaces that make extensive use of point-and-click input methods. While some data items, such as the patient's name, may require input in (structured) textual or numeric form, many data items can be input simply through the use of a mouse or other pointing input device (e.g., a touch screen) to make selections from pre-set options in drop-down menus and/or sets of checkboxes and/or radio buttons or the like.

While some clinicians may appreciate the ability to directly enter structured data into an EHR through a point-and-click interface, other clinicians may be reluctant to take the time to learn where all the boxes and buttons are and what they all mean in an EHR user interface, and may instead prefer to simply enter text into a free-form note. Moreover, some clinicians may prefer to take advantage of the time savings that can be gained by providing notes through verbal dictation, as speech can often be a faster form of data communication than typing or clicking through forms.

Accordingly, in some embodiments, speech input that is processed by an ASR system may include speech related to a medical report, such as speech relating to a patient encounter between a clinician and a patient. Text resulting from the ASR may be intended to be input to an EHR, and may be processed following output by the ASR system to be inserted into an EHR.

The inventor has recognized and appreciated that an EHR for a patient may include medical data or other information collected and input by a potentially large number of different clinicians, or that may be input over a long period of time that may include multiple different visits by a patient to a healthcare facility. For example, during a single visit to a healthcare facility, it is possible that an administrator may collect identifying information for a patient as well as medical history information for the patient, and input this information to the EHR. A nurse may collect various vital signs and may conduct a preliminary interview with a patient to learn of symptoms the patient is exhibiting, and input that information to the EHR. A physician may conduct a more detailed examination of the patient and a more detailed interview, and may prescribe lab work or other tests be done, and input his or her notes of the encounter into the EHR. A technician performing the tests ordered by the doctor may input results into the EHR and a doctor may subsequently review the test results and input to the EHR a description of the results and/or a conclusion based on the results. These are just examples of the types of information that may be input to an EHR, but it should be appreciated that an EHR may have many and diverse sources of information.

In addition, in some circumstances like these where there are multiple clinicians inputting information to a patient's EHR, it is possible that each of the clinicians may be operating different systems to generate and store different information. For example, members of the healthcare facility may produce documentation using specialized medical documentation software, handwritten reports, photos, images generated by diagnostic machines, speech recognition software, and many other tools.

The inventor recognized and appreciated that the volume of information collected for an EHR, and the variety of sources of that information, poses challenges for medical professionals in a healthcare facility to input new information to an EHR. For example, as part of preparing new information to be input to an EHR, one clinician may depend on information input by another clinician, such as in the case that a doctor is inputting information that depends on lab results generated and input by a technician. When the doctor and the technician use different systems, the doctor may not be able to retrieve the necessary information within the system the doctor is using, when the doctor requires that information. Instead, the doctor may need to switch to another system, or otherwise obtain the information, before continuing with the doctor's task. This may be even more complicated when the information the doctor needs is not yet available at the time (e.g., because lab work is not yet complete, or information has not yet been entered into a database) that the doctor is completing his/her task, as the doctor may need to stop and wait for the information to become available before completing the task, inserting unnecessary delay.

The inventor recognized and appreciated the advantages that would be offered by a system that enables a user to input information including provisional text. Provisional text may be used to reference a data field of a data set such as an EHR, and may be interpreted to yield data stored in the EHR at that data field. Using provisional text, the clinician may be able to continue with his/her text even when the clinician is not aware of particular information that the clinician requires to include in a report, and even if that information is not available when the clinician requires it.

Accordingly, described herein are embodiments of a system that processes input from a user, where in some cases the user may be a clinician and the input may include medical information to be input to an EHR. In some embodiments, the input may be in the form of speech input dictated by the clinician. The speech input may include speech identifying provisional text, which may be in the form of a tag or a tag text, and may be in accordance with a defined pattern for provisional text, such as by being a word or phrase that begins with a particular symbol character. The speech input for the provisional text may be processed by an ASR along with other speech input to produce a text that includes the provisional text, which in embodiments that use a symbol character to signal provisional text, will include the symbol character before each of the provisional texts. The provisional text may appear within other text, but is to be replaced with substitute text before the whole text is finalized.

The provisional text may, in some cases, be references to data fields of an EHR and may be a request for related information from an EHR to be inserted as the substitute text. For example, if a clinician is dictating a note regarding a patient and does not immediately know the patient's age, rather than searching for the patient's age the clinician may simply dictate provisional text referencing the patient age data field. Subsequently, the provisional text may be replaced with substitute text that includes the patient's age.

Accordingly, following receipt of text (e.g., results of ASR on speech input), the text may be examined to identify provisional texts within the text, including by scanning the text for character strings matching the pattern defined for provisional texts. If a provisional text is identified, text of the provisional text may be interpreted to identify a data field to which the provisional text relates. Interpreting the provisional text may include interpreting solely the text of the provisional text, or by interpreting the provisional text in context with other parts of the text, such as a part of the text identifying a patient to which the text relates or other aspects of the content of other parts of the text. A data value for that data field may then be determined, which may include querying an EHR for a data value stored in that data field. Substitute text may be generated including the data value, and the text may be edited to replace the provisional text with the substitute text. After editing, the text may in some embodiments be transmitted for storage in an EHR.

In some embodiments, provisional text may additionally or alternatively include commands in the form of provisional text. The commands may, similar to the examples described above, trigger retrieval of information from data sources including EHR databases and/or other medical record systems, or other sources. Other provisional text may trigger storage of documentation information in EHR databases outside of one in which documentation was originally produced. Other embodiments relate to systems and techniques for handling information received from outside of an EHR application of a healthcare facility. Some embodiments may incorporate the use of provisional text to assist in processing data received from scanned physical documents, photos of text, and other information outside of the EHR application. In some embodiments, provisional text may be used to map storage of information to correct fields of a dataset and also trigger execution of certain actions related to items received from outside of the EHR application. In other embodiments, provisional text may be mapped to programmed actions. The system may identify provisional text in a document and then utilize a mapping of provisional text to programmed instructions to determine a set of actions to be performed. The system may then perform the set of actions. The actions may include generating and sending emails, commanding machines to execute functions, printing, and/or other tasks. It is appreciated that current systems require these actions to be executed manually by a human user. Embodiments discussed herein allow automation of actions using easy to enter inputs from a user such as tag strings.

Some embodiments discussed herein relate to systems for processing or inputting text to unmodifiable documents. In a healthcare facility, for example, physical documents may be scanned into electronic form. In other cases, there may be web forms obtained from different websites. In some cases, these documents and forms cannot be edited. In some embodiments, an overlaid field may be provided on top of the document to allow a user to enter text into the document. The field of the document may be mapped to a particular provisional text, which is further mapped to a field of a dataset. By dictating provisional text corresponding to a command, text that is dictated for storage in particular data fields may be entered into the overlaid fields of the form, allowing a user to use existing, un-editable documents to record information without having to recreate documents in an editable form.

It should be appreciated that the foregoing description is by way of example only, and some embodiments are not limited to providing any or all of the above-described functionality. Different embodiments may provide some or all of the functionality described herein. While a number of inventive features for clinical documentation processes are described above, it should be appreciated that embodiments may include any one of these features, any combination of two or more features, or all of the features, and some embodiments are not limited to any particular number or combination of the above-described features. While some embodiments may address one or more above-discussed shortcomings of traditional methods and/or may provide one or more of the foregoing benefits, it should be appreciated that other embodiments may not provide any of the above-discussed benefits and/or may not address any of the above-discussed deficiencies that the inventors have recognized in conventional techniques. Embodiments can be implemented in any of numerous ways, and are not limited to any particular implementation techniques. Described below are examples of specific implementation techniques; however, it should be appreciate that these examples are provided merely for purposes of illustration, and that other implementations are possible.

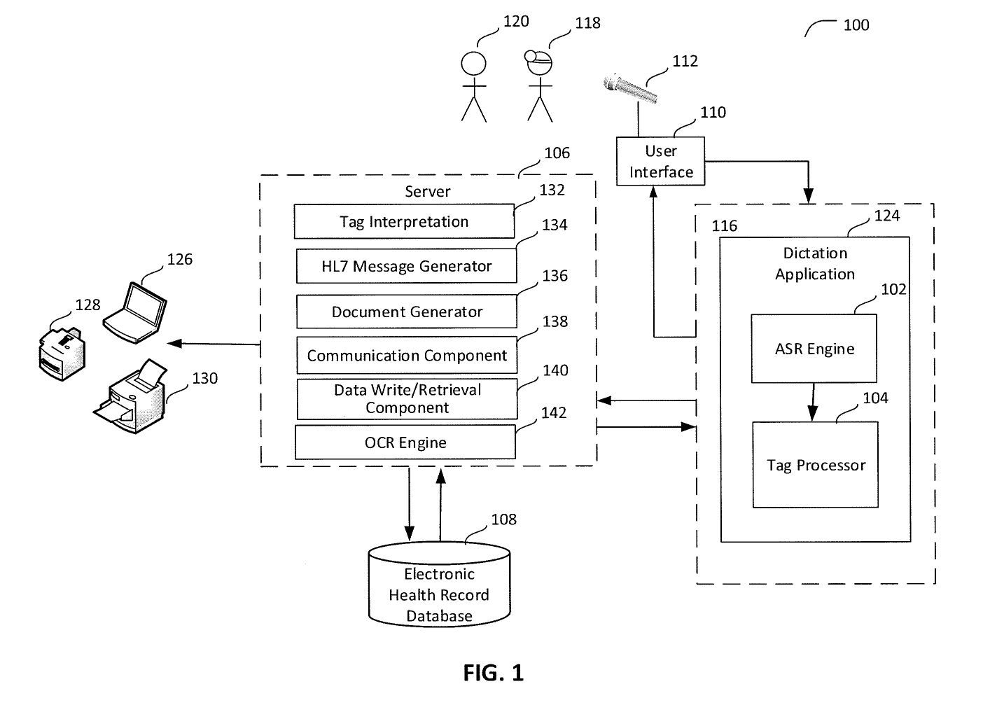

One illustrative application for the techniques described herein is for use in a system for enhancing medical documentation processes. An exemplary operating environment for such a system is illustrated in FIG. 1. As depicted, exemplary system 100 includes a client system 116 and a server system 106. Each of these processing components of system 100 may be implemented in software, hardware, or a combination of software and hardware. Components implemented in software may comprise sets of processor-executable instructions that may be executed by the one or more processors of system 100 to perform functionality described herein. Each of the components of client system 116 and/or server system 106 may be implemented as a separate component of the system, or any combination of these components may be integrated into a single component or a set of distributed components. It should be understood that any such component depicted in FIG. 1 is not limited to any particular software and/or hardware implementation and/or configuration.

System 100 includes a user interface 110 to enable a user 118 to interact with a client 116. User interface 110 is configured to interact with users to receive input and display outputs. Client 116 may be any suitable computing device, including a laptop or desktop personal computer or a mobile device such as a mobile phone (including a smart phone), a personal digital assistance (PDA), or a tablet device. In some embodiments, client 116 may include an application such as dictation application 124, and user interface 110 may permit the user 118 to interact with the dictation application 124. User interface 110 itself may be a component of the dictation application 124 or a separate application used to receive input.

Embodiments are not limited to operating with any particular user interface 110. In some embodiments, user 118 may operate user interface 110 to input to client 116 audio of speech, text input via a keyboard, or point-and-click input using a selection device like a mouse or touchscreen. Where user interface 110 is adapted to receive audio of speech, user 118 may input the audio to client 116 using suitable audio input device(s), such as a microphone 112. The user 118 may utilize these input devices in conjunction with viewing visual components of the user interface 110. In some embodiments, user 118 may utilize any of various suitable forms of peripheral devices with combined functionality, such as a touchscreen device that includes both display functionality and manual input functionality via the same screen, and thereby embodies both an output device (e.g. display) and an input device.

Embodiments are not limited to operating with any particular type of user 118. Some embodiments may relate to a healthcare facility or to medical information. In such cases, the user 118 may be a clinician, including a physician, nurse, technician or other medical practitioner. In some such cases, the information input by the clinician 118 may relate to a patient 120, such as in a case where a clinician 118 dictates information for a medical report concerning an encounter between clinician 118 and patient 120 or dictates other medical information regarding patient 120 that is to be stored in an EHR for the patient 120. In some such cases, the physician 118 may use operate the user interface 110 for the client 116 to dictate the medical documentation, which is input to the dictation application 124.

When audio of speech is input via the user interface 110 for the dictation application 124, the user interface 110 may pass the speech input to an automated speech recognition (ASR) engine 102 of the dictation application 124. The ASR engine may be configured to perform an ASR process on the input speech to generate one or more recognition results for the speech, which may be text including words and/or phrases corresponding to the words and/or phrases spoken by user 118 in the speech input, serving as a text transcription of the speech input. The dictation application 124 may receive the recognition result(s) from the ASR engine 102 and output the recognition result(s) to the user interface 110. The user interface 110 may then present the recognition results to the user 118.

As should be appreciated from the foregoing, in some embodiments input (e.g., speech input, keyboard input) from a user may include provisional text. Though, it should be appreciated that embodiments are not limited to receiving text in any particular manner, and that any text (e.g., text retrieved from long-term storage) may include provisional text and be processed in accordance with techniques described herein. The provisional text may be in the form of tag strings, which may be placeholders for other information to be inserted, such as text including data values for a data field indicated by the tag string, image information, or other type of information.

Accordingly, as illustrated in FIG. 1, dictation application 124 may include a tag processor 104 configured to receive text output by the ASR engine 102 following performance of ASR on speech input or on text input directly from the user interface 110 (e.g., via a keyboard), or text originating from other sources. In some embodiments, the tag processor 104 may identify, within input text, tag strings that may be used as provisional text, which are to be replaced with substitute text and/or that may trigger programmed actions. While illustrated in FIG. 1 as a component of dictation application 124, in some embodiments the tag processor 104 may be separate from the dictation application 124 and run as a separate application on the client 116.

In some embodiments, tag strings may comprise a string of textual characters that conform to a predefined pattern for tag strings. Tag strings may, for example, be strings that begin with a particular symbol character, which in some embodiments may be a hash character (i.e. the “#” symbol) but may in other embodiments be another suitable symbol or combination of symbols. The tag processor 104 can identify tag strings in text received at the processor 104 by comparing character strings in the text to the predefined pattern. Once identified, the tag processor 104 may use tag strings to execute various programmed actions, or to determine substitute text to be inserted in place of the tag strings. Specific example actions associated with tag strings will be discussed in detail below.

In some embodiments, as part of processing the tag strings, the client 116 may communicate with a server 106, which may be configured to execute applications or other processes that perform services, including that perform services with which other applications (e.g., dictation application 124) may communicate. For example, the tag processor 104 may be configured to generate tag string identification information that is sent to the server 106, to a service running on the server 106. The server 106 can perform one or more actions associated with processing and/or acting on the tag strings, and may send information back to the client 116. The tag processor 104 may use the information received from the server 106 to carry out actions and display results of those actions to the user interface 110.

In some embodiments, the server 106 may include a communication component 138, which may be implemented as executable instructions stored on a medium of the server 106 and executes on one or more processors of the server 106, and which may include functionality for receiving data over a network and/or via inter-process communication on the server 106, including from the client 116. The data items may comprise, for example, files that include textual data (which may include provisional text such as tag strings), images, and other information the server 106 may use to execute actions associated with tag strings. The communication component 138 of the server may also output data to the client 116. The output data may comprise files containing textual data and other information (e.g., images, videos) that the client 116 may use to carry out further actions.

In the embodiment of FIG. 1, textual information on tag strings that is received by the communication component 138 may be passed to a tag interpretation service 132, which may be implemented as executable instructions stored on a medium of the server 106 and executes on one or more processors of the server 106. The tag interpretation service 132 may evaluate received tag strings to determine actions to take based on the tag strings, including whether the tag string references a programmatic action to take and whether the tag string references a data field of a data store (e.g., a data field of an EHR). The tag interpretation service 132 is not limited to implementing the interpretation in any particular manner. In some embodiments, the tag interpretation service 132 may maintain a mapping of tag strings to various data fields of a dataset, programmed actions, and/or data fields of a document. Accordingly, in some embodiments, the tag interpretation service 132 may use a mapping to identify a data field of a data set that corresponds to a tag string. The data field may be a specific field of a data store, such as a database. Additionally or alternatively, the service 132 may map a tag string to a program action, which may include mapping a tag string to a field containing executable instructions that may be executed by one or more computing devices, such as the server 106 and/or the client 116. The instructions, when executed, may cause the executing device to take a variety of actions, including generating a document or sending an email, for example. Additionally or alternatively, the service 132 may also map a tag string to a field of a document, such as a specific field of a form. The information from the form may be mapped to a data set by a mapping of the field of the form to a data field of the data set.

In some embodiments, as part of interpreting a tag string, the server 106 may be configured to generate and send one or more queries to one or more data stores. The query may be a query for a data value stored in a data field of the data store, such as in the case that the tag string is interpreted to correspond to a data field. In some embodiments in which the data store may be an EHR and the stored information may be medical information, the server 106 may include a HL7 message generator 134, which may be implemented as executable instructions stored on a medium of the server 106 and executes on one or more processors of the server 106. Health Level 7 (HL7) represents an international standard for transferring data between different healthcare systems used by different healthcare providers, and HL7 messages may be used to transfer medical information between healthcare systems. In some embodiments, the server 106 may use HL7 message generator 134 to generate a query for a data value stored in a data field of an EHR, by issuing a query as an HL7 message, and may receive a response in the form of an HL7 message that includes the data value. In addition, in some embodiments, the server 106 may also transmit to the client 116, as a result of an interpretation, an HL7 message that includes a data value (or a text including a data value), such that in some cases, the dictation application 124 (and/or tag processor 104) may be configured to receive and process an HL7 message.

In some embodiments, the server 106 may contain a component such as an optical character recognition (OCR) engine, which may be implemented as executable instructions stored on a medium of the server 106 and executes on one or more processors of the server 106 to process images of text received from different sources. In some cases, clinicians may request storage in an EHR of information that is captured in an image of text, by inputting that image to the client 116 via user interface 110. A clinician may, for example, take a photo of a physical document and request to store the text in it, or request presentation of the text to the clinician for review (and possible editing) prior to storage. In such a case, the client 116 may include the functionality to process the image using OCR technologies or, in other embodiments (such as the embodiment of FIG. 1), the client 116 may send the image to an OCR engine 142 executed by the server 106. The OCR engine 142 may process the image and generate text. The text may be returned to the client 116. In some cases, the user 118 may have input to the user interface 110 a tag string. In other cases, the generated text may include a tag string. In any case, the tag string may be interpreted by the tag processor 104 and/or tag interpretation service 132 to refer to the text embedded in the image that was processed by the OCR engine 142. In such a case, the tag string may also indicate a data field of a data set in which the extracted text is to be stored. In such a case, when the text is extracted from the image and when the tag string is interpreted to correspond to a programmatic action, the client 116 and/or server 106 may act to store the text in the data field, including through generating and sending an HL7 message using the HL7 message generator 134.

In some embodiments, the server 106 may also include a data write/retrieval component 140, which may be implemented as executable instructions stored on a medium of the server 106 and executes on one or more processors of the server 106 to execute various dataset operations such as data writes and data retrieval. The component 140 may access a dataset such as an EHR data store 108. In some embodiments, the data store may be a data store that organizes a collection of data with a certain schema, such as a relational database, XML file, or other type of storage. In other embodiments, the database can comprise a non-relational database or otherwise be a data store without set or defined schema. The database may further comprise one or more distributed data sets that are stored in distributed locations. The datasets may be accessed by a single interface such as an application program interface (API) of the database. The data write/read component 140 can utilize the API to write and retrieve data from the data store 108. Furthermore, the data write/retrieval component 140 may execute database operations based on tag strings. For example, in response to receiving one or more tag strings and information associated with the tag strings, the tag interpretation service 132 may interpret the tag strings and map the tag strings to data fields of EHR data store 108. The data write/retrieval may store information associated with the tag strings in locations of the data store 108 specified by the tag interpretation service 132. In another example, the server 106 may receive tag strings that are mapped to locations in the data store 108. The data write/retrieval component 140 may utilize the tag string mapping to retrieve data from the mapped locations of data store 108.

In some embodiments, the server 106 may also include a document generation component 136, which may be implemented as executable instructions stored on a medium of the server 106 and executes on one or more processors of the server 106. The document generator 136 may collect information and incorporate it into a specific type of document. The document can then be stored, transmitted to another system, or used for other purposes. In one embodiment, document generation may be commanded by tag strings. For example, the tag interpretation service 132 may maintain a mapping of tag strings to instructions to generate a document. When the server 106 receives a set of such tag strings, the document generator 136 may execute the instructions to generate and output a document to one or more locations. In some embodiments, as part of generating the document, the document generator 136 may gather information according to a received set of tag strings and include the information in a generated document. Additionally or alternatively, in some embodiments, the document generator 136 may output documents to a device 126 (e.g., a computer, fax machine, mobile device, etc.). In one example, a tag string may be mapped to instructions to gather certain information and generate an email message, a Simple Messaging Service (SMS) message, or other text message. When the server 106 receives the particular tag string and the tag string is interpreted by the tag interpretation service 132, the server 106 may execute the instructions to gather information into the form of a text message. Further, the text message may be automatically sent by the document generator 136 to a separate device 126, such as by conveying the text message to an appropriate server (e.g., mail server) together with an identifier for an intended recipient of the text message, or transmitted to a client 116 for displaying on a user interface 110. In cases in which a text message is transmitted to another device 126, rather than to a user interface 110, an intended recipient of the message may be determined, such as by scanning through text that includes the provisional text, and/or the provisional text or other provisional text included in the text, to identify a name, email address, phone number, or other identifier for an intended recipient. The document generator 136 may generate documents in a variety of formats (e.g., emails, text files, and other document types).

In some embodiments, any or all of the above-discussed components of the server 106 can alternatively or additionally be components of the client 116. Furthermore, the components may be distributed across one or more devices that comprise the server 106 or client 116. For example, the client 116 may be distributed or replicated on a multi-server system to provide redundancy and efficiency of service. In other embodiments, the user interface 110 may also communicate directly with the server 106.

It is appreciated that the configuration of system 100 is shown herein by example and not limitation. Further, any of the programmatic actions described above (or elsewhere herein) as performed by the server 106 in response to interpretation of a tag may be, in whole or in part, performed by the client 116. For example, instead of the server 106 executing instructions, the instructions may be transmitted to the client 116 and the client 116 may execute the instructions. Further, the user interface 110 may also interact directly with the server 106. The server 106 may comprise one or more computers and may be maintained by a healthcare facility, a third party, or another service provider. In some embodiments, the server 106 and client 116 may be incorporated in a single computer system. In other embodiments, the server 106 or client 116 may be distributed across a plurality of devices that may be located in a single location or in several different locations. The plurality of devices may communicate with each other over a wired network or wireless communication network.

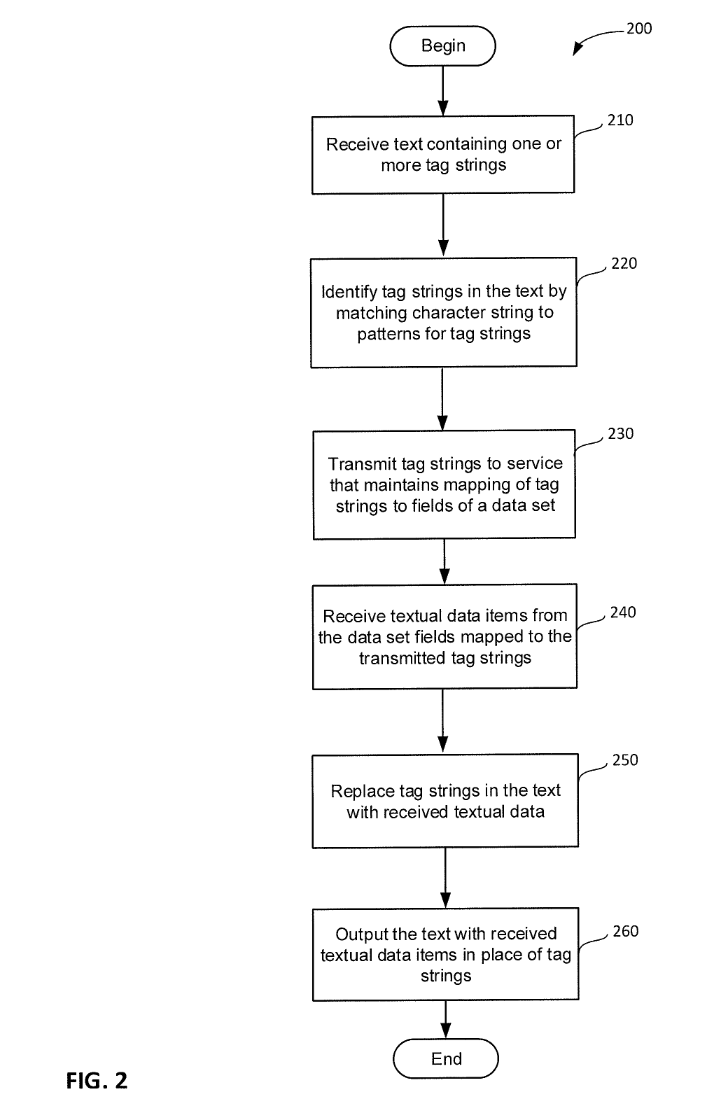

FIG. 2 illustrates an exemplary process 200 that may be performed, for example, by a system that includes a tag processor and tag interpretation service, such as client 116 and/or server 106 of FIG. 1, for utilizing tag strings to retrieve information from a data set such as an EHR. Prior to the start of the process 200, a character pattern for provisional text may be identified and a tag processor may be configured with the character pattern, such that the tag processor may review text to determine whether there is a match between the character pattern and any character strings of the text. For example, the character pattern may include a symbol (e.g., the hash symbol, “#”) followed by text. In some embodiments, prior to the start of process 200, a mapping between defined provisional text and defined data fields may be created, such that there is a known set of provisional text and a known connection to particular data fields. Such a mapping may be used to identify a data field to which a provisional text corresponds, and thus a data value for a data field for substitute text for the provisional text.

Process 200 begins in block 210, in which the client may receive user input specifying a text containing one or more provisional texts, which may be tag strings. The client may receive input entered manually into a device such as client device 116, which may be a computing device including a mobile device or other device. In some embodiments, the client may receive input, including tag strings. For example, a user 118 may dictate, via a dictation application, into an input device 112 (e.g., a microphone). An ASR engine 102 may then process the dictation as described above and output a set of text containing tag strings. In such a case, the text may be input to a tag processor 104.

In some embodiments, tag strings can comprise a sequence of text characters following one or more defined patterns for tag strings. A tag string may, in some cases, mark a place in a set of text for where information is to be inserted, in the form of substitute text that replaces the tag string. In embodiments described herein, tag strings can be used to automatically determine relevant information for a tag string and to insert that relevant information into text.

At act 220, a tag processor 104 may identify one or more tag strings in the received set of text by matching one or more character strings to the pattern(s) for tag strings. A defined pattern for a tag string may comprise a sequence of text characters that begin with one or more symbols designated for tag strings. For example, a sequence of text characters beginning with a hash symbol (i.e. “#”) may specify a tag string. In one embodiment, the tag processor 104 may scan the text and identify all strings that match the defined pattern for tag strings. The tag processor 104 may then compile all the tag strings. The tag processor 104 may, for example, put the tag strings into a file.

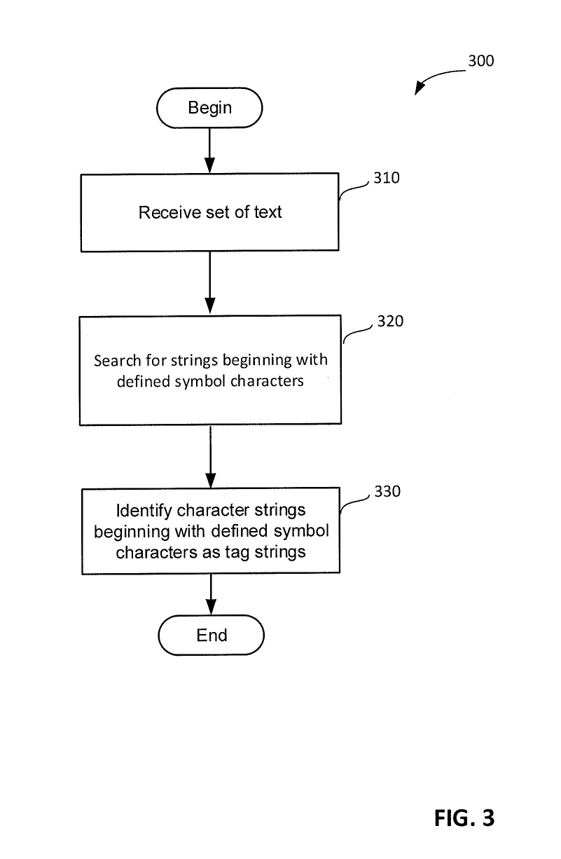

FIG. 3 illustrates an exemplary process 300 that may be performed to identify tag strings in a set of text. The process 300 may be performed by any suitable system such as the client device 116 discussed above with reference to FIG. 1. At act 310, the tag processor 104 receives a text. At act 320, the tag processor 104 may search the set of text for strings beginning with defined symbol characters that specify a tag string. For example, the tag processor 104 may search for all strings that begin with a hash symbol. At act 330, the tag processor 104 identifies each character string that begins with the hash symbol as a tag string. The tag processor 104 may for example, generate a file that includes all of the identified tag strings. The file may contain a list of tag strings in the order that they appear in the received set of text.

Referring again to FIG. 2, following the identification of block 220, the tag processor 104 may interpret the tag strings. Interpreting the tag strings may include determining a data field indicated by the tag string. The tag processor 104 may perform the interpreting, as laid out in the example of FIG. 2, by using a service separate from the tag processor 104, and potentially executing on another device, to compare a tag string to a mapping or otherwise evaluating the tag string to identify an indicated data field. In other embodiments, though, the tag processor 104 may perform the interpreting by itself identifying a data field using a mapping or otherwise evaluating the tag string.

Accordingly, in the example of FIG. 2, at act 230 the tag processor 104 transmits the tag strings to a service that maintains a mapping of tag strings to data fields of a dataset (e.g., tag mapping service 132), such as to data fields of an electronic health record (EHR). The service may be executed by a device other than the one executing the tag processor 104, such as server 106. The tag processor 104 may transmit individual tag strings separately or may transmit a compiled set of tag strings identified from the text. In some embodiments, the tag processor 104 may transmit a file containing a list of the tag strings. The tag processor 104 may, for example, place the file in a location that can be accessed by the service. In other embodiments, the tag processor 104 may transmit the file to the service over a network interface. The tag mapping service 132 may maintain a mapping of one or more tag strings to one or more fields of a dataset. The fields of the dataset may comprise fields in a database such as EHR data store 108.

Upon receiving the tag string(s), the service 132 interprets the tag strings. In some embodiments, the service 132 may interpret the tag strings using a mapping of tag strings to data fields of a dataset. For example, tag interpretation service 132 may identify, in the mapping, a matching tag string for an input tag string, and identify a data field that the mapping indicates is associated with the matching tag string. The matching tag string may, in such a case, be a tag string that has an identical set of characters as the input tag string.

In some embodiments, the service 132 may perform the interpretation of a tag string based solely on the characters of the tag string itself. In other embodiments, however, the interpretation of a tag strings may depend in part on a context in which the tag string appears. The context may include information about a text in which the tag string appears, including a document in which the tag string appears and/or a text unit (e.g., a paragraph, sentence, or phrase) in which the tag string appears. The context may indicate, for example, a meaning of the tag string within the document or the text unit. For example, the context may indicate a type of document, such as a type of medical report. A corresponding data field for a tag string may depend in part on a particular report, such as in a case that data fields may have the same name (and be associated with an identical tag string) for different reports. In such a case, resolving which data field is indicated may depend on the type of report. As another example, the context may indicate a patient or other person to which a text relates. A corresponding data field for a tag string may depend in part on a person to whom the text relates, such as a case where a tag string asks for a person's “age” or “address” or other information unique to the person. Identifying which data field is indicated, such as the particular record (for a particular person) for the data field, may depend on the context such as the identity of the person.

In cases in which context information is used by the tag interpretation service 132, that context information may be provided to the interpretation service 132 by the tag processor 104 or by another source, separately or together with the tag string(s). The context information may be derived from the text in which the tag string appears, such as by performing a rules-based analysis or a natural language processing on the text to extract information from the text, which facts may indicate context individually or collectively. For example, the set of text may contain a particular patient ID number which indicates to the service to use a mapping of tag strings to dataset fields associated with a particular patient. If, for example, the text contains a patient ID for John Smith, the tag strings may map to dataset fields that contain information relevant only to John Smith. The context information may additionally or alternatively be derived from metadata associated with a text. For example, dictation application 124 may have access to metadata that is associated with the text and describes the speech input that was input and the text that was generated from the speech input, such as a person (e.g., patient) to which the speech/text relates or a form (e.g., medical report) to which the speech/text relates.

In some embodiments, as part of interpreting a tag string, service 132 may query a data store, such as an EHR data store 108. In some such embodiments, data write/retrieval component 140 may retrieve information from data fields identified as corresponding to tag strings. The data retrieval component 140 may, for example, access an API of data store 108 to retrieve a data value from each identified data field. Data that is received by the component 140 may comprise substitute information to be inserted in place of the tag strings in the text generated by the ASR engine 102. In some embodiments, the substitute information may be in the form of text. Substitute text may therefore include data values for data fields to which the tag strings were determined to correspond. In some embodiments, the data values received by component 140 may be placed into a file with the associated tag strings, such that the file includes tag strings and corresponding substitute text for each tag string. The communication component 138 may then transmit the file to the client 116.

Accordingly, at act 240, the tag processor 104 may receive a file including substitute information (e.g., substitute text) for each of the tag strings that had been detected in act 220. At act 250, the tag processor 104 replaces tag strings in the text with the received substitute information. In some embodiments, the tag processor 104 may automatically select each tag string in the text and replace it with the textual data items associated with the tag string. As a result, the text contains the substitute information in place of the original tag strings.

Next, at act 260 of exemplary process 200, the tag processor 104 outputs the text with received textual data items in place of tag strings. In some embodiments, the tag processor 104 may output the text in a user interface such as user interface 110. In some embodiments, the tag processor 104 may be part of the original input application in which the user inputted the set of text with the tag strings. In other embodiments, the tag processor 104 may operate as a separate application that interfaces with the original input application. In both embodiments, the tag processor 104 can replace the tag string with the received textual data items in the original input application. For example, a physician 118 may have been dictating a patient encounter report into a field of an EHR application. The tag processor 104 may replace tag strings that were inputted into the field of the EHR application with the received textual data items. In some embodiments, the tag processor 104 may generate a separate display and output the text in the separate display. Further, the tag processor 104 may output the text in the form of an electronic message, a printed paper document, or store the text in a dataset. It is appreciated that this allows a physician or other health professional to incorporate information from many different sources by simply dictating tag strings into the physician's report without any manual search, copy, or paste actions. Further, the physician or health professional can incorporate information without having to have knowledge of where the information is stored and/or how it would be retrieved manually.

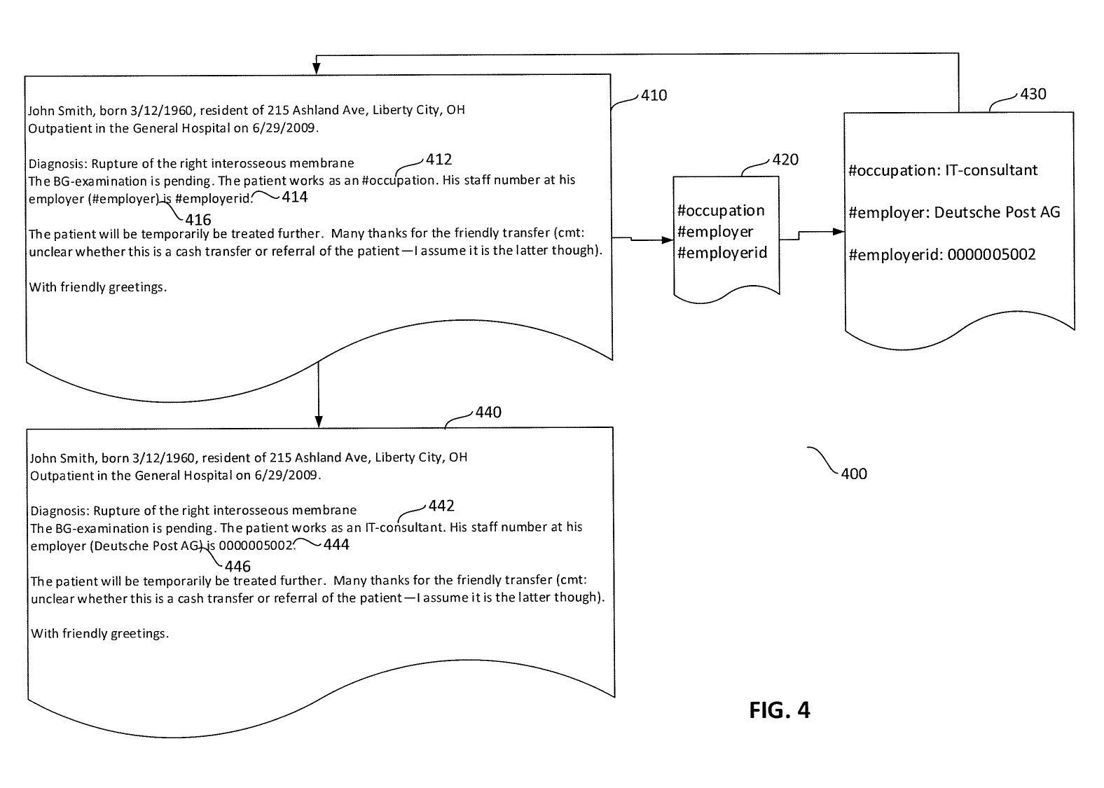

FIG. 4 illustrates an exemplary data process flow 400 to retrieve data using tag strings and replace the tag strings with associated data. Process flow 400 begins with a received set of text 410. The received set of text, as discussed above, can be input by a user 118 through a user interface 110. In the example of FIG. 4, the received set of text 410 comprises a medical report about a patient. The received set of text 410 includes tag strings 412, 414, 416 that begin with a hash symbol. A tag processor 104 identifies the tag strings by, for example, searching the text 410 for character strings that being with the hash symbol. The tag processor 104 may then generate a list of all the identified tag strings 420. The list may comprise a text file containing the tag strings.

The identified tag strings 420 are then transmitted to a service that maintains a mapping of tag strings to fields of a dataset. The service may be part of a server 106. The server 106 may look up the tag strings in the mapping to identify fields of the dataset. The server 106 may then retrieve information from the dataset, such as by performing a query of the dataset on each of the identified fields corresponding to the identified tag strings. As discussed above, in some embodiments, the query of the dataset may include information derived from the provisional text and/or from the text and/or from other provisional text to determine a context in which the provisional text appears. The context may provide information on a meaning of the provisional text, such as by providing information identifying a field in the dataset referenced by the provisional text. The information identifying the field may identify a patient. For example, the provisional text “#age” may refer to an “age” field but, to query the dataset, it may be helpful or necessary to perform the query on a particular patient record, to receive an age for a particular patient. Context information from the text may identify a patient and/or patient record to be queried. As another example, context information may help identify a field of the dataset to be queried. For example, provisional text like “#lab_value” may be interpreted as referencing some value for some lab work that was done for a patient. Context information may be helpful in determining which lab work was referenced, such as by identifying the type of test that was run from the text or other provisional text and querying for a value resulting from that type of test, or by identifying a date on which the text was generated and using the date to query for values for lab work that was done most closely in time or otherwise proximate in time to the time the text was generated. Any suitable information may be used to determine a context in which a provisional text appears, and any suitable data or metadata for a text or for a provisional text may be used as context information in different embodiments.

The server 106 may, for example, produce a text file such as one illustrated in 430. The illustrated file 430 includes the identified tag strings along with the corresponding retrieved data. The file 430 may be transmitted to the tag processor 104 which can replace the tag strings in the original string with the associated retrieved information to produce illustrated file 440. The file 440 has the same content as file 410 with the tag strings 412, 414, and 416 replaced with textual data items 442, 444, and 446. The illustrated file 440 may be outputted to a user interface of an application in which a user input the text 410, outputted in an electronic message, printed on a paper, stored in a dataset, or outputted in another manner.

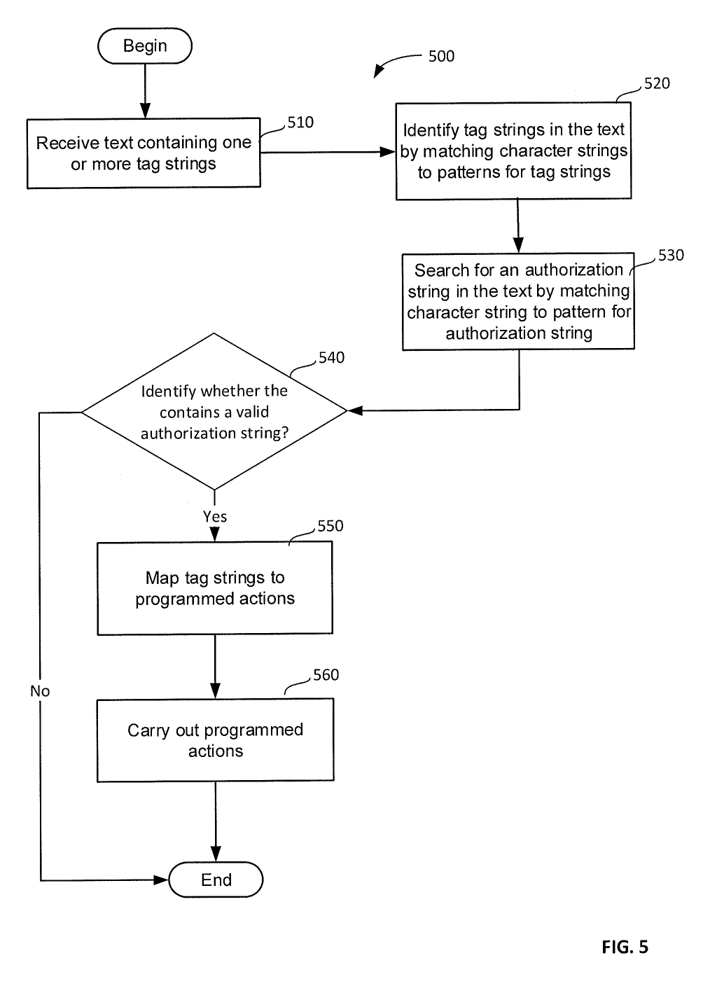

FIG. 5 illustrates an exemplary process for an embodiment in which authorization strings are utilized. Authorization strings are a type of tag string that grant access to a user to execute certain actions. In some embodiments, the client 116 or the server 106 may grant permission to execute certain actions based on a particular authorization string in a set of text. An authorization string, similar to a tag string, may be identified according to a defined pattern for authorization strings. Authorization strings may be unique to individual users. The client 116 or the server 106 may store permissions for different authorization strings to automatically grant or block access. In some embodiments, authorization strings may be identified by a symbol different than a symbol used for tag strings.

At act 510 of exemplary process 500, the client system 116, receives text containing one or more tag strings. At act 520, a tag processor such as tag processor 104 may identify tag strings by matching character strings to patterns for tag strings as described with respect to exemplary process 200 above. At act 530 the tag processor 104 may proceed to search for an authorization string in the text by matching character strings to a pattern for authorization strings. The pattern for authorization strings may, for example, comprise strings beginning with a star symbol, i.e. “*”. Similar to processes described for identifying tag strings (e.g. process 300), the tag processor 104 can search for authorization strings by, for example, searching for strings beginning with defined symbol character for authorization strings. The tag processor 104 may identify strings beginning with the defined symbol character as an authorization string. At act 540 the client system 116 determines whether the text contains a valid authorization string.

At act 540, if the server 106 determines that the text does not contain a valid authorization string 540, the system ends the process and prevents execution of any action. The system may, for example, determine that the text contains no authorization string. In this case the system may end the process. In other cases, the system may identify an authorization string but identify that the authorization string is not granted permissions for certain requested actions. A service such as tag mapping service 132 may maintain a mapping of authorization strings to permissions. When receiving a request to execute actions, a server 106 may look up an identified authorization string in the mapping to identify permitted actions. If certain requested actions are not allowed, the server 106 may terminate the process. At act 540, if the server 106 determines that the text contains a valid authorization string 540, the system may map tag strings to respective programmed actions based on a service that maintains a mapping of tag strings to programmed actions. At act 560, the server 106 may proceed to execute the programmed actions. The programmed actions may comprise retrieval of data as described in exemplary process 200 or other programmed actions.

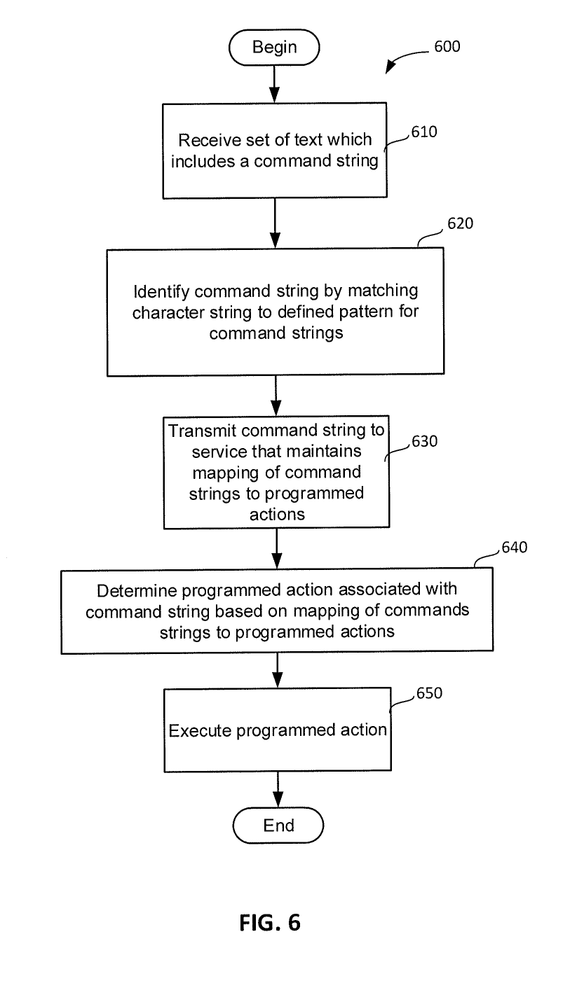

FIG. 6 illustrates an exemplary process 600 in which embodiments utilize command strings to execute programmed actions. At act 610 of exemplary process 600, the system may receive a set of text which includes a command string. The set of text may be received by a client system such as client 116 shown in FIG. 1. The set of text may be inputted by manual entry into a device or by dictation. In the case of dictation, an ASR engine 102 may process dictation to generate a set of text capturing the dictated information. At act 620, the tag processor 104 may identify one or more command strings in the received set of text by matching character strings in the text to defined patterns for command strings. A defined pattern for a command string can comprise a sequence of text characters that begin with one or more symbols designated for command strings. For example, a sequence of text characters beginning with a hash symbol, i.e. “#”, can specify a command string. In one embodiment, the tag processor 104 may scan the set of text and identify all strings that match the defined pattern for command strings. The tag processor 104 may then compile all the command strings. The tag processor 104 may, for example, put the command strings into a file.

Next, at act 630 of exemplary process 600, the tag processor 104 transmits the command strings to a service that maintains a mapping of command strings to programmed actions. The tag processor 104 may transmit a compiled set of command strings identified from the set of text to the service. In some embodiments, the tag processor 104 may transmit a file containing a list of the command strings to the service. The tag processor 104 may, for example, place the text file in a location that can be accessed by the service. In other embodiments, the tag processor 104 may transmit the file to the service over a network interface. The service can comprise a server that maintains the mapping such as server 106 with tag mapping service 132. The tag mapping service 132 may maintain a mapping of one or more command strings to programmed actions. The mapping may map a command string to computer readable instructions that, when executed, cause the server to carry out programmed actions. In one embodiment, the service may map a command string to a field of a dataset wherein the field of the dataset contains instructions for execution. The mapping of the command string to the field of the dataset may remain constant while instructions may be modified or updated as needed. The field of the dataset can, for example, be a field of an EHR database such as EHR data store 108 shown in FIG. 1.

Next, at act 640 of exemplary process 600, the server 106 may determine one or more programmed actions associated with an identified command string based on a mapping of command strings to programmed actions. Upon receiving the command string, the server 106 may look up the command string in the mapping to identify associated programmed actions. The server 106 may, for example, identify program instructions that the command string is mapped to. In one example, the service 132 may maintain a mapping of the command string to a set of program instructions.

Next, at act 650 of exemplary process 600, upon identifying the associated programmed actions, the server 106 may execute the programmed actions. The server 106 may, for example, execute an identified set of program instructions.

Command strings may comprise tag strings that trigger execution of a programmed actions. In some embodiments, command strings may be utilized to automate the process of executing certain programmed actions. In some embodiments, command strings may follow a predefined pattern designated for command strings. Programmed actions may include gathering information, generating files or messages which include gathered information, transmitting files or messages, sending commands to machines, and other actions. It is appreciated that there is no limitation to programmed actions that may be triggered by command strings. Embodiments discussed herein with regard to actions triggered by command strings are discussed by way of example only and not limitation. A healthcare facility may map command strings to any programmed actions that may be required at the healthcare facility. The service that maintains the mapping of command strings to actions may be managed by the healthcare facility or a separate party. Furthermore, the mapping may be modified and updated.

In order to identify command strings in a received set of text, systems of some embodiments may use a process similar to the one used to identify tag strings. The exemplary process 300 illustrated in FIG. 3 may be carried out to identify the command strings. At act 310 the system (e.g. client system 116) may receive a set of text. The tag processor may then search for command strings by searching for strings that begin with a defined symbol character for command strings. The tag processor may, for example, search for strings that begin with a hash symbol, i.e. “#”. The defined pattern and/or symbol designated for command strings may be the same as or different from the defined pattern and/or symbol designated for tag strings. At act 330, the tag processor may identify character strings beginning with a defined symbol character for command strings as the command strings. The tag processor may, for example, generate a file that includes a list of all identified command strings identified in the set of text.

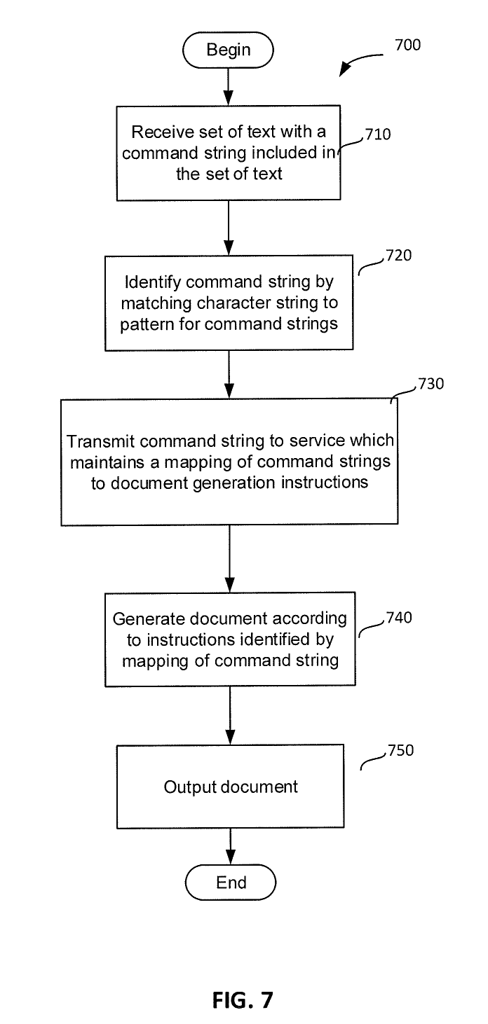

Actions that may be advantageous for documentation in healthcare facilities are those related to document generation. FIG. 7 illustrates an exemplary process 700 by which some embodiments may use command strings to carry out document generation. At act 710, the client system 116 may receive a set of text with a command string included in the set of text. The set of text may be received as manual input or dictation from a user interface. Dictation may be processed by an ASR engine to produce the set of text. At act 720, the tag processor 104 may identify the command string in the set of text by matching character strings to a defined pattern for command strings as discussed above.

At act 730 of exemplary process 700, the client system 116 may transmit the identified command string to a service that maintains a mapping of command strings to document generation instructions (e.g. server 106). The service 132 may, for example, map the identified command string to instructions to generate an email message, generate a structured document or generate another document. In some embodiments, the structured document may be in the form of an HL7 message. At act 740, the server 106 may be configured to generate one or more documents according to the instructions identified by the mapping of command string to program instructions. The server 106 may, for example, generate an email containing information specified in the set of text and automatically prepare the email for sending in an email application. The server 106 may also generate a pdf document that is attached to an email. In another example, the server 106 may generate an HL7 message (or other structured information).

After generating the message, at act 750 of exemplary process 750 the server 106 may output the generated document. The server 106 may, for example, output an email draft to the client 116 which may display the message to a user on a user interface 110. Alternatively, the server 106 may automatically send the generated email. In cases in which the generated document is an HL7 message, the server 106 may distribute the message to one or more other healthcare systems. In some embodiments, the server 106 may output the HL7 message to a machine to trigger one or more actions by the machine. Some embodiments may include automatic HL7 message generation. HL7 messages may be used to transfer information between different healthcare systems. HL7 represents an international standard for transferring data between different healthcare systems used by different healthcare providers. Furthermore, HL7 messages can be transmitted to machines that can interpret HL7 messages and execute actions accordingly. For example, an HL7 message may trigger a printer in a healthcare facility to print documents. In some embodiments, an HL7 message may trigger a medical imaging machine to execute a process. For example, the HL7 message may command an x-ray machine to take an x-ray image of a patient or configure the x-ray machine settings to prepare it for taking an x-ray image of a patient in a particular manner, which may be specified by the HL7 message and may have been determined from the tag string and/or from context information determined from the text (including other provisional text) of which the tag string is a part. The automatic generation of HL7 messages may allow automation of tasks in a healthcare facility and also sharing of information between disparate healthcare systems. Command strings may be mapped to instructions to generate an HL7 message as discussed above. The instructions may, for example, comprise computer readable steps that take information and input them into a file in HL7 format to produce an HL7 message. The HL7 message can then be transmitted to various systems.

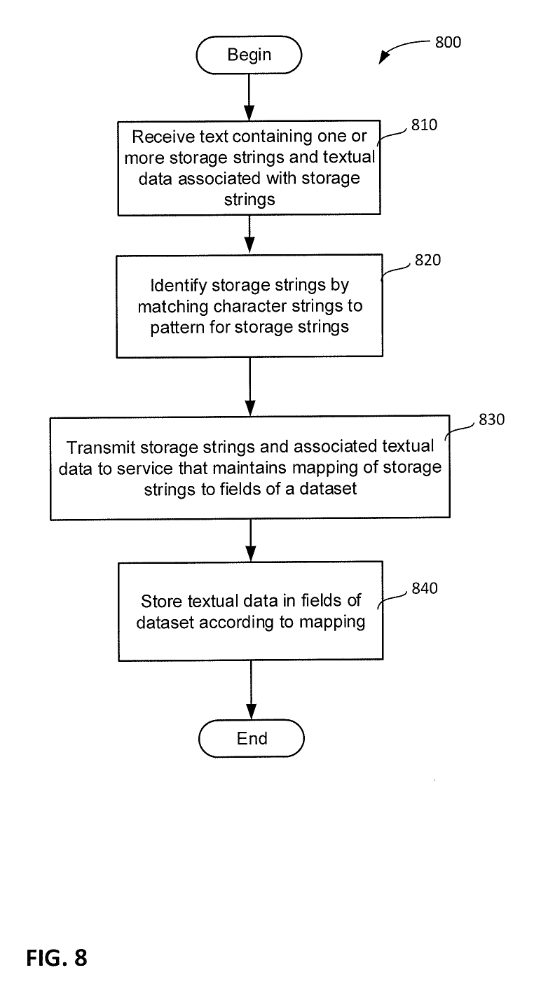

Other programmed actions that may be carried out using command strings are those related to storage of information. FIG. 8 illustrates an exemplary process 800 which may be used in some embodiments to carry out programmed actions related to using storage strings. At act 810 of exemplary process 800, the client system 116 may receive text containing on or more storage strings along with textual data associated with those storage strings. The text may be received from a user through a user interface such as user interface 110. A user may input text manually using a keyboard or dictate via a dictation application 124. The client 116 may receive the inputted information. In the case that the information is dictated, the dictation application 124 may utilize an ASR engine to process dictation into a set of text. At step 820 of exemplary process 800, the client system 116 identifies storage strings by matching character strings to patterns defined for storage strings. In some embodiments, a tag processor 104 of the dictation application 124 may identify the storage strings. The tag processor 104 may, for example, identify storage strings using exemplary process 300 illustrated in FIG. 3 similar to a process used for tag strings and other command strings as discussed above.

A storage string may comprise a command string that specifically triggers programmed actions related to storing of information. Storage strings may be identified according to a predefined pattern for storage strings similar to tag strings and other command strings. Storage strings may have their own unique pattern. Alternatively or additionally storage strings may have the same predefined pattern as tag strings and/or command strings.

Next, at act 830, the client system 116 may transmit the storage strings and associated textual data to a service that maintains a mapping of storage strings to fields of a dataset (e.g. interpretation service 132). In some embodiments, the service 132 may map one or more storage strings to one or more fields of a dataset. The dataset may comprise an EHR database such as EHR data store 108. The database may comprise a relational database with several fields or may alternatively comprise a non-relational database with a plurality of documents. The tag mapping service 132 may maintain a mapping of storage strings to specific fields in the data store 108. In some embodiments, the mapping to the fields may remain constant while information may be added to, modified, and/or removed from the fields. Additionally or alternatively, the tag mapping service 132 may map one or more storage strings to program instructions that, when executed by the server 106 cause the server 106 to store information in a particular location. The program instructions, when executed, may cause the server 106 to locate a particular field of a dataset (e.g. database 108) in which to store the information. At act 840 of exemplary process 800, the server 106 may store textual data in fields of a dataset according to the mapping. The server 106 may identify the fields associated with the identified storage strings. The server 106 may further identify information (e.g., textual data) associated with the identified storage strings that are to be stored. The server 106 may then store the information in fields of a dataset (e.g. data store 108). The server 106 may, for example, utilize an API to execute database write processes to store the textual data items in fields designated by the mapping.

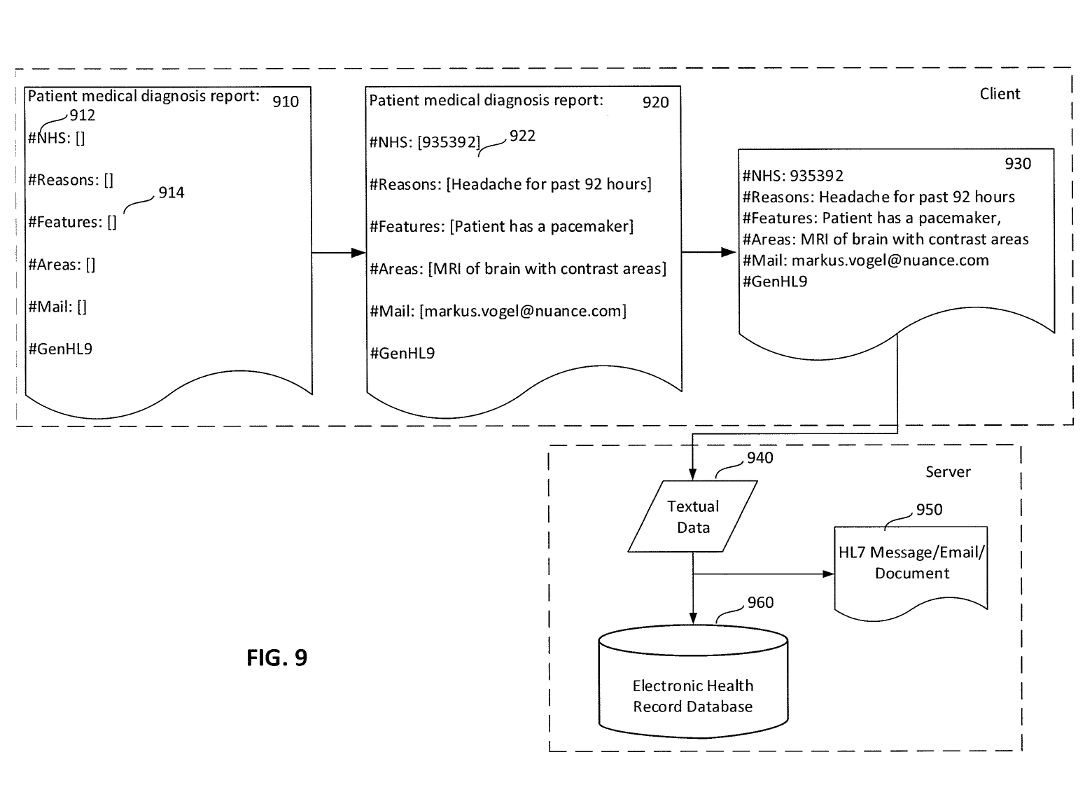

FIG. 9 illustrates an example data process flow to store textual data items using storage strings. A medical professional may create a patient medical diagnosis report 910 which includes one or more storage strings such as storage string 912. The client may generate a template patient medical diagnosis report for the user to use. Alternatively, the user may open up an application and produce the patient medical diagnosis report. In some embodiments, the user can produce the patient medical diagnosis report at any cursor position. The medical professional may input textual information for each storage string such as textual information 922 to produce a completed patient medical diagnosis report 920. The medical professional may, for example, dictate each storage string and information associated with each storage string to a dictation application 124. The dictation application may utilize an ASR engine 102 to process the dictation into text to produce a completed patient medical diagnosis report 920 with textual data items 922 associated with storage strings. The client 116 may process the report to identify all storage strings and their associated textual data items. A tag processor 104 may identify the storage strings along with their textual data items. The tag processor 104 may, for example, generate a file 930 containing the storage strings along with their associated textual data items. The client may transfer these files to the server 106 which may maintain a mapping of storage strings to fields of a dataset (e.g. tag mapping service 132). The server 106 may look up fields mapped to the storage strings and then store the associated textual data 940 in those fields. The fields may be fields of a database such as EHR database 960. Additionally or alternatively, the storage strings may also be mapped to instructions to generate documents or carry out other programmed actions. In this case, the server may further generate a document such as an HL7 message, email, pdf, or other document 950 as described above.

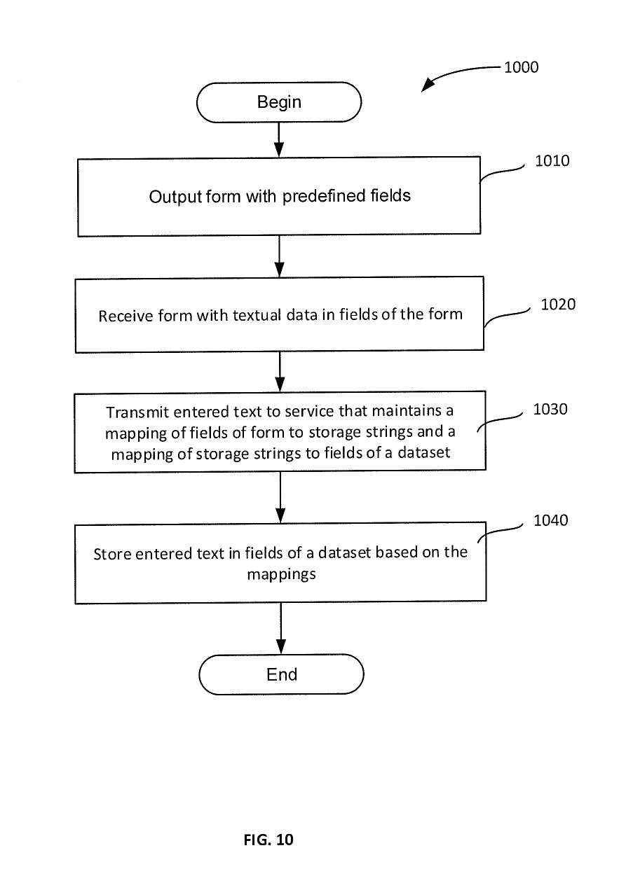

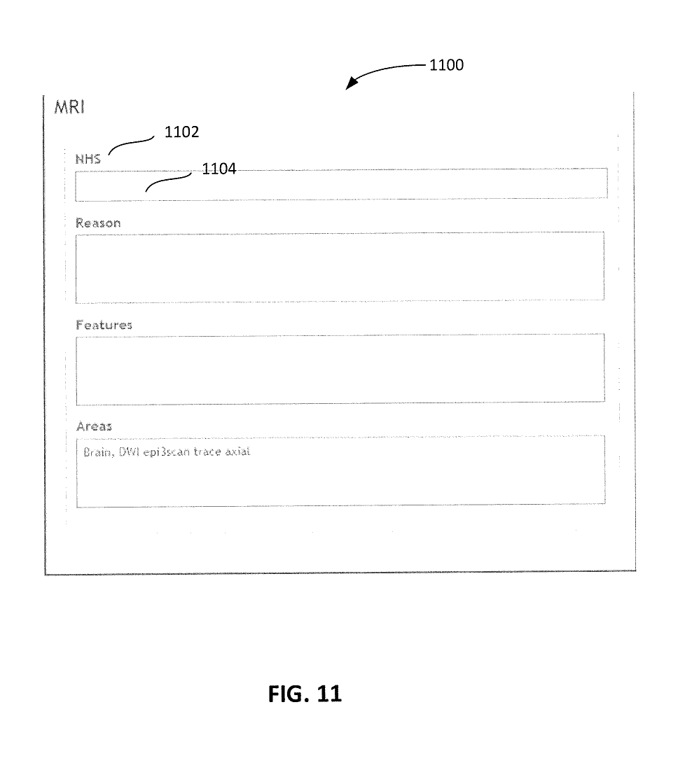

As yet another example, in some embodiments a client system (e.g. client system 116) may identify a form with predefined fields that are mapped to storage strings. FIG. 10 illustrates an exemplary process 1000 in which a form with predefined fields is used with mapped storage strings in order to store data. At act 1010 of exemplary process 1000 the client system 116 may output a form to a user interface 110. The client 116 may access the form from a dataset of forms or from another location. The form may comprise a set of fields which may receive input text. An example form is illustrated in FIG. 11. The form may include one or more fields such as field 1104 which are configured to receive text. Text may be entered into the form using a dictation application 124 with an ASR engine as described above.

At act 1020, the client may receive a form with textual data in fields of the form. The client 116 may, for example, receive the form in response to a voice command to the dictation application 124 or any other suitable method of submission by the user. At act 1030, the client 116 may transfer the form with textual data in fields of the form to a service (e.g., server 106) that maintains a mapping of fields of the form to storage strings and a mapping of storage strings to fields of a dataset. In some embodiments, the server 106 may automatically analyze the form to map fields to specific storage strings. The server 106 may use the mappings to identify fields of the dataset in which the textual data in the fields of the form is to be stored. At act 1040 of exemplary process 1000, the server 106 may store textual data from fields of the form in fields of a dataset based on the mappings. The fields of a dataset may comprise fields of an EHR database such as EHR data store 108.

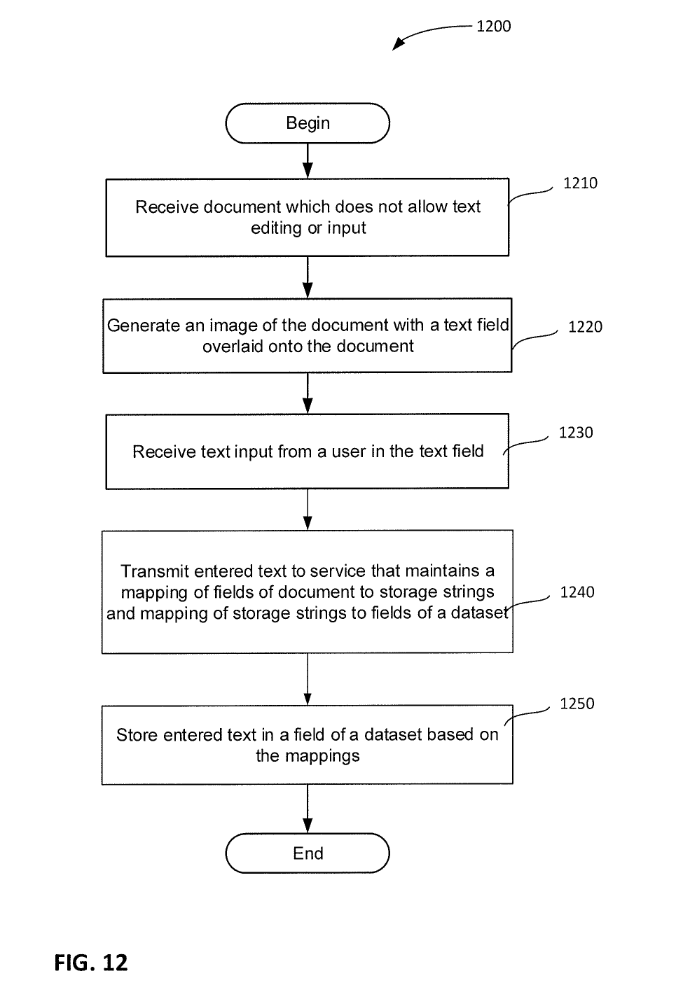

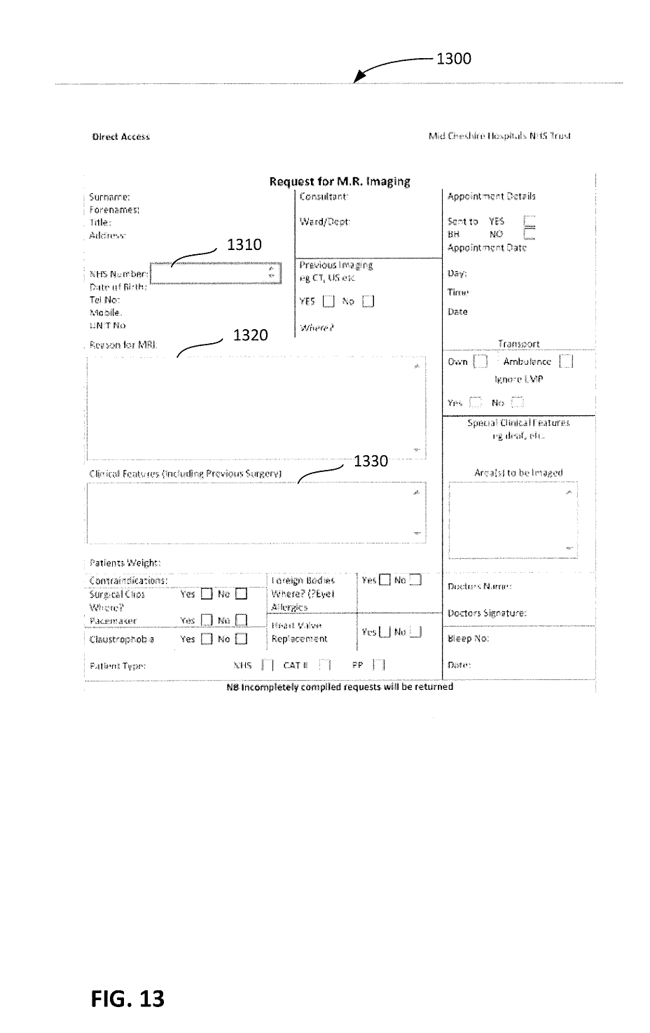

In another example, some embodiments include additional methods to use tag strings to store information from documents that cannot be edited. FIG. 12 illustrates an exemplary process 1200 to store information entered into a document that does not allow text editing or input. At act 1210, the client 116 may receive a document which does not allow text editing or input. The document may comprise a scanned pdf, screenshot of a webpage, or other document that does not include ability to enter text. One example document 1300 is illustrated in FIG. 13. The document 1300 may, for example, have been scanned by a user and submitted. A medical professional may need to add information (e.g., text, image, or other information) to the document and store it to record a patient encounter or other record.

At act 1220, the client 116 may generate an image of the received document 1300 with one or more input fields such as fields 1310, 1320, 1330 overlaid onto the document 1300. The input fields may be configured to receive input information (e.g., text, images, other information) from a user. The client 116 may, for example, generate a new pdf version of the received document image with editable text fields overlaid. In another example, the input fields may be displayed in an interface overlaid on the received document, without editing the underlying document or creating a new document. At act 1230, a user may input information (e.g., text) into the fields using a dictation application such as dictation application 124. Alternatively, the user may manually enter text into the fields. The client 116 may receive the entered text and then, at act 1240, transmit the form 1300 with text entered into the overlaid fields to a service that maintains a mapping of fields of the document to storage strings and a mapping of storage strings to fields of a dataset (e.g. server 106). In some embodiments, the tag mapping server 106 may automatically analyze the document to generate a mapping of fields of the document to storage strings. Alternatively, the server 106 may have a predefined mapping of document fields to storage strings (e.g. tag mapping service 132). At act 1250, the server 106 may use the mappings to store textual data items from fields of the document into fields of a dataset such as EHR database 108.

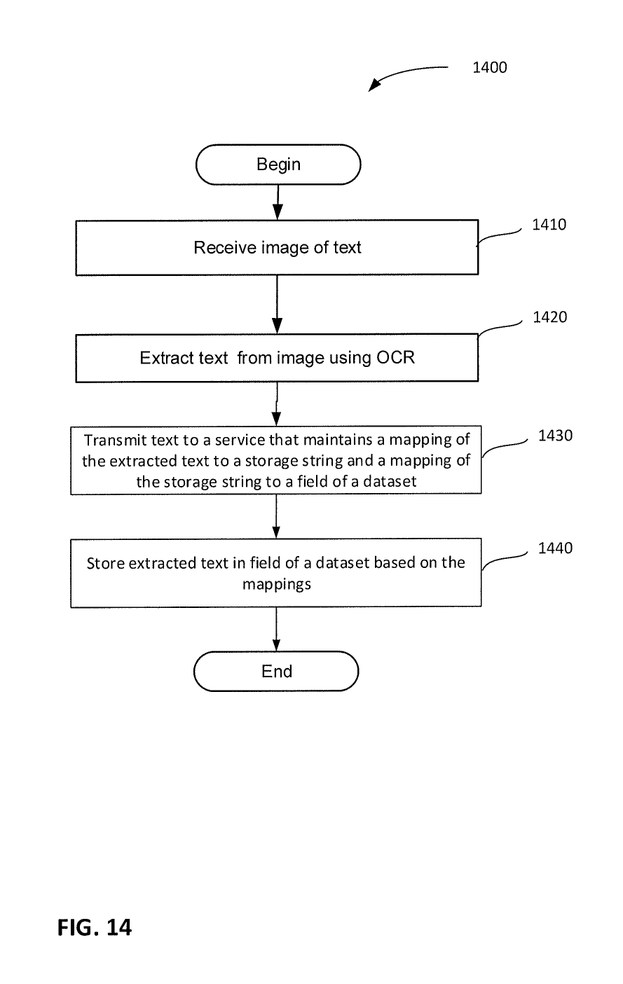

In yet another example embodiment, the system may include components and methods to store textual data from images of text. FIG. 14 illustrates one exemplary process 1400 in which an image of text may be stored using provisional text (e.g., storage strings). At act 1410, an image of text may be received by a server such as server 106. Then at act 1420, the server 106 may extract text from the image. The server 106 may process the image using an OCR engine such as OCR engine 142. The OCR engine 142 may produce a set of text that can be modified, edited, and stored. The OCR engine 142 can, for example, generate a text file including the text extracted from the image.

In some embodiments, the extracted text may include provisional text (e.g., in the form of a storage string). Additionally or alternatively, the server 106 may receive a storage string inputted by a user (e.g., via a user interface of an application received by the client system 116) associated with the extracted text. In some embodiments, the tag service 132 may analyze the text and/or meta-information about the text to associate the text to a specific storage string. For example, the OCR text may comprise information about a particular patient. The server 106 may recognize this based on meta-information about the text and the text itself and accordingly associate a particular storage string configured to trigger storage of the text in one or more fields of a dataset designated for storing information about the patient (e.g., an EHR).

Next, at act 1430, the extracted text may then be transmitted to a service such as tag interpretation service 132 that maintains a mapping of the storage string to a field of a dataset. At act 1440, the server 106 may use the mappings to store the extracted text. The server 106 may, for example, look up the storage string associated with the extracted text and then look up the mapped dataset field. The server 106 may then store the textual data in the appropriate dataset field. The dataset field may be a field of a database such as EHR data store 108.

The above described embodiments can be implemented in any of numerous ways, as the concepts are not limited to any particular manner of implementation. For instance, the present disclosure is not limited to the particular arrangement of components and services shown in the various figures, as other arrangements may also be suitable. Further, the examples discussed herein are not limited to accessing electronic health records as embodiments are not limited in this respect. Such examples of specific implementations and applications are provided solely for illustrative purposes.

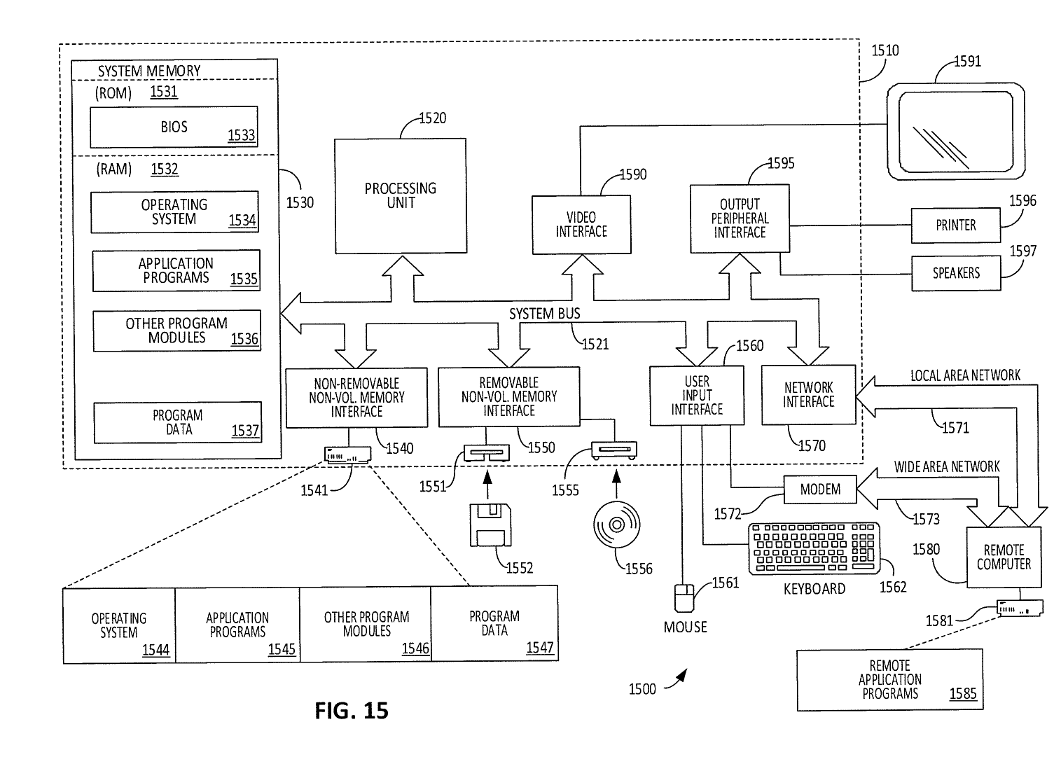

FIG. 15 illustrates an example of a suitable computing system environment 1500 in which some embodiments may be implemented. A computing system such as the example illustrated in FIG. 15 may be used in some embodiments to implement server 106 and/or client system 116, for example. However, it should be appreciated that the computing system environment 1500 is only one example of a suitable computing environment and is not intended to suggest any limitation as to the scope of use or functionality of the described embodiments. Neither should the computing environment 1000 be interpreted as having any dependency or requirement relating to any one or combination of components illustrated in the exemplary operating environment 1500. For example, some embodiments of a computing system usable with techniques described herein (e.g., to implement any of the system components described herein, such as server 106 and/or client system 116) may include more or fewer components than illustrated in the example of FIG. 15.

Embodiments are operational with numerous other computing system environments or configurations. Examples of well-known computing systems, environments, and/or configurations that may be suitable for use with the described techniques include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc., that perform particular tasks or implement particular abstract data types. The embodiments may also be practiced in distributed computing environments where tasks are performed by remote processing devices that are linked through a communications network. In a distributed computing environment, program modules may be located in both local and remote computer storage media including memory storage devices.

With reference to FIG. 15, an exemplary system for implementing the described techniques includes a computing device in the form of a computer 1510. Components of computer 1510 may include, but are not limited to, a processing unit 1520, a system memory 1530, and a system bus 1521 that couples various system components including the system memory to the processing unit 1520. The system bus 1521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1510 typically includes a variety of computer readable media.

Computer readable media can be any available media that can be accessed by computer 1510 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other non-transitory medium which can be used to store the desired information and which can accessed by computer 1510. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 1530 includes computer storage media in the form of volatile and/or nonvolatile memory such as read only memory (ROM) 1531 and random access memory (RAM) 1532. A basic input/output system 1533 (BIOS), containing the basic routines that help to transfer information between elements within computer 1510, such as during start-up, is typically stored in ROM 1531. RAM 1532 typically contains data and/or program modules that are immediately accessible to and/or presently being operated on by processing unit 1520. By way of example, and not limitation, FIG. 15 illustrates operating system 1534, application programs 1535, other program modules 1536, and program data 1537.

The computer 1510 may also include other removable/non-removable, volatile/nonvolatile computer storage media. By way of example only, FIG. 15 illustrates a hard disk drive 1541 that reads from or writes to non-removable, nonvolatile magnetic media, a magnetic disk drive 1551 that reads from or writes to a removable, nonvolatile magnetic disk 1552, and an optical disk drive 1555 that reads from or writes to a removable, nonvolatile optical disk 1556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1541 is typically connected to the system bus 1521 through a non-removable memory interface such as interface 1540, and magnetic disk drive 1551 and optical disk drive 1555 are typically connected to the system bus 1521 by a removable memory interface, such as interface 1550.

The drives and their associated computer storage media discussed above and illustrated in FIG. 15 provide storage of computer-readable instructions, data structures, program modules and other data for the computer 1510. In FIG. 15, for example, hard disk drive 1541 is illustrated as storing operating system 1544, application programs 1545, other program modules 1546, and program data 1547. Note that these components can either be the same as or different from operating system 1534, application programs 1535, other program modules 1536, and program data 1537. Operating system 1544, application programs 1545, other program modules 1546, and program data 1547 are given different numbers here to illustrate that, at a minimum, they are different copies. A user may enter commands and information into the computer 1510 through input devices such as a keyboard 1562 and pointing device 1561, commonly referred to as a mouse, trackball or touch pad. Other input devices (not shown) may include a microphone, joystick, game pad, satellite dish, scanner, touchscreen, or the like. These and other input devices are often connected to the processing unit 1520 through a user input interface 1560 that is coupled to the system bus, but may be connected by other interface and bus structures, such as a parallel port, game port or a universal serial bus (USB). A monitor 1591 or other type of display device is also connected to the system bus 1521 via an interface, such as a video interface 1590. In addition to the monitor, computers may also include other peripheral output devices such as speakers 1597 and printer 1596, which may be connected through an output peripheral interface 1595.

The computer 1510 may operate in a networked environment using logical connections to one or more remote computers, such as a remote computer 1580. The remote computer 1580 may be a personal computer, a server, a router, a network PC, a peer device or other common network node, and typically includes many or all of the elements described above relative to the computer 1510, although only a memory storage device 1581 has been illustrated in FIG. 15. The logical connections depicted in FIG. 15 include a local area network (LAN) 1571 and a wide area network (WAN) 1573, but may also include other networks. Such networking environments are commonplace in offices, enterprise-wide computer networks, intranets and the Internet.

When used in a LAN networking environment, the computer 1510 is connected to the LAN 1571 through a network interface or adapter 1570. When used in a WAN networking environment, the computer 1510 typically includes a modem 1572 or other means for establishing communications over the WAN 1573, such as the Internet. The modem 1572, which may be internal or external, may be connected to the system bus 1521 via the user input interface 1560, or other appropriate mechanism. In a networked environment, program modules depicted relative to the computer 1510, or portions thereof, may be stored in the remote memory storage device. By way of example, and not limitation, FIG. 15 illustrates remote application programs 1585 as residing on memory device 1581. It will be appreciated that the network connections shown are exemplary and other means of establishing a communications link between the computers may be used.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with one or more processors programmed using microcode or software to perform the functions recited above.

In this respect, it should be appreciated that one implementation comprises at least one computer-readable storage medium (i.e., a tangible, non-transitory computer-readable medium, such as a computer memory (e.g., hard drive, flash memory, processor working memory, etc.), a floppy disk, an optical disk, a magnetic tape, or other tangible, non-transitory computer-readable medium) encoded with a computer program (i.e., a plurality of instructions), which, when executed on one or more processors, performs above-discussed functions. The computer-readable storage medium can be transportable such that the program stored thereon can be loaded onto any computer resource to implement functionality discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed functionality.

The phraseology and terminology used herein is for the purpose of description and should not be regarded as limiting. The use of “including,” “comprising,” “having,” “containing”, “involving”, and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements from each other.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method comprising:
evaluating text resulting from performance of automatic speech recognition (ASR) on audio of speech to determine whether the text includes provisional text, wherein evaluating the text comprises determining whether character strings of the text match a character pattern for provisional text;
in response to identifying a provisional text in the text,
interpreting the provisional text to yield substitute text, the substitute text including a value for a data field that the interpreting determines is indicated by the provisional text, and
editing the text to replace the provisional text with the substitute text.

2. The method of claim 1, wherein interpreting the provisional text comprises interpreting the provisional text together with other content of the text to determine the data field indicated by the provisional text.

3. The method of claim 1, wherein interpreting the provisional text comprises interpreting the provisional text together with metadata regarding the text to determine the data field indicated by the provisional text.

4. The method of claim 1, wherein:
the text is at least a portion of a medical report regarding a patient; and
interpreting the provisional text comprises interpreting the provisional text together with information indicating an identity of the patient.

5. The method of claim 1, wherein interpreting the provisional text comprises querying a data store for a data value stored in the data field indicated by the provisional text.

6. The method of claim 5, wherein:
the text is at least a portion of a medical report regarding a patient; and
querying the data store comprises querying an electronic health record of a patient for the data value stored in the data field of the electronic health record of the patient.

7. The method of claim 1, wherein interpreting the provisional text comprises:
transmitting, via at least one communication network, the provisional text together with a request that the provisional text be interpreted; and
receiving, in response to the transmitting, the substitute text including the value for the data field.

8. The method of claim 1, wherein interpreting the provisional text comprises comparing the provisional text to a mapping of character strings to data fields to determine a matched character string and a data field corresponding to the matched character string.

9. The method of claim 1, wherein interpreting the provisional text comprises transmitting the provisional text to a service that maintains a mapping of character strings to data fields, wherein the mapping maps each different character string of a plurality of defined character strings to a different data field of one or more sets of data.

10. The method of claim 1, further comprising:
receiving the audio of speech, the audio of speech including speech corresponding to the provisional text, the speech corresponding to the provisional text including speech corresponding to a symbol character associated with provisional text; and
requesting that the ASR be performed on the audio of speech.

11. The method of claim 1, wherein determining whether character strings of the text match a character pattern for provisional text comprises determining whether the text includes a character string beginning with a symbol character.

12. At least one computer-readable storage medium having encoded thereon executable instructions that, when executed by at least one processor, cause the at least one processor to carry out a method comprising:
evaluating text to determine whether the text includes provisional text, wherein evaluating the text comprises determining whether character strings of the text match a character pattern for provisional text;
in response to identifying a provisional text in the text,
interpreting the provisional text to yield substitute text, the substitute text including a value for a data field that the interpreting determines is indicated by the provisional text, and
editing the text to replace the provisional text with the substitute text.

13. The at least one computer-readable storage medium of claim 12, wherein interpreting the provisional text comprises interpreting the provisional text together with other content of the text to determine the data field indicated by the provisional text.

14. The at least one computer-readable storage medium of claim 12, wherein:
the text is at least a portion of a medical report regarding a patient; and
interpreting the provisional text comprises querying an electronic health record of a patient for the data value stored in the data field of the electronic health record of the patient.

15. The at least one computer-readable storage medium of claim 12, wherein interpreting the provisional text comprises:
transmitting, via at least one communication network, the provisional text together with a request that the provisional text be interpreted; and
receiving, in response to the transmitting, the substitute text including the value for the data field.

16. An apparatus comprising:
at least one processor; and
at least one storage medium having encoded thereon executable instructions that, when executed by the at least one processor, cause the at least one processor to carry out a method comprising:
evaluating text to determine whether the text includes provisional text, wherein evaluating the text comprises determining whether character strings of the text match a character pattern for provisional text;
in response to identifying a provisional text in the text,
interpreting the provisional text to yield substitute text, the substitute text including a value for a data field that the interpreting determines is indicated by the provisional text, and
editing the text to replace the provisional text with the substitute text.

17. The apparatus of claim 16, wherein interpreting the provisional text comprises interpreting the provisional text together with other content of the text to determine the data field indicated by the provisional text.

18. The apparatus of claim 16, wherein:
the text is at least a portion of a medical report regarding a patient; and
interpreting the provisional text comprises querying an electronic health record of a patient for the data value stored in the data field of the electronic health record of the patient.

19. The apparatus of claim 16, wherein interpreting the provisional text comprises:
transmitting, via at least one communication network, the provisional text together with a request that the provisional text be interpreted; and
receiving, in response to the transmitting, the substitute text including the value for the data field.

20. The apparatus of claim 16, wherein:
the text is at least a portion of a medical report regarding a patient; and
interpreting the provisional text comprises interpreting the provisional text together with information indicating an identity of the patient.
